(19) United States
(12) Patent Application Publication
(10) Pub. No.: US 2010/0066489 A1
(43) Pub. Date: Mar. 18, 2010

(54) SECURITY-ENABLED DIGITAL MEDIA AND AUTHENTICATION METHODS THEREOF

(76) Inventors: Gene Fein, Lenox, MA (US); Edward Merritt, Lenox, MA (US)

Correspondence Address: Stolowitz Ford Cowger LLP, 621 SW Morrison St, Suite 600, Portland, OR, 97205, US

(21) Appl. No.: 12/603,091

(22) Filed: Oct. 21, 2009

Related U.S. Application Data
(62) Division of application No. 11/613,953, filed on Dec. 20, 2006.
(60) Provisional application No. 60/752,187, filed on Dec. 20, 2005.

(51) Int. Cl. G06F 7/04; H04N 5/91

(52) U.S. Cl. 340/5.8; 386/94; 386/124; 386/125; 386/E05.004

(57) ABSTRACT

Embodiments of methods, devices and/or systems for security-enabled digital media and authentication methods thereof are described.

### RELATED APPLICATIONS

The current patent application is a divisional of U.S. Non-Provisional Patent Application No. 11/613,953, filed on Dec. 20, 2006, which claims priority to U.S. Provisional Patent Application No. 60/752,187, filed on Dec. 20, 2005.

### FIELD

This disclosure is related to articles of merchandise such as digital media, security measures that may be applied thereon and authentication thereof.

### BACKGROUND

Conventional types of security tags and methods of authenticating articles of merchandise may not be particularly robust. For example, conventional security tags may include a bar code disposed on an outer wrapping of an article of merchandise comprising an article of digital media such as a compact disc (CD). Additionally, other types of security tags may include a uniquely colored CD, a CD which responds uniquely to lighting conditions such as black light, a pressed manufacturers identification number which may be pressed into a CD at the time of manufacturing, a number pressed onto a CD at a mass manufacturers as a secondary pressing process, and other physical markings on a CD that may be used for visual identification. Authentication of articles of merchandise using these types of security tags may comprise scanning a bar code, physical inspection, or employing a reader or translator to verify an alphanumeric code, for example. However, these conventional authentication methods may not adequately safeguard against counterfeit products. These conventional methods may employ relatively few security tags to perform authentication, and the few security tags may be frequently spoofed or defeated.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 illustrates one embodiment of an article of merchandise comprising an article of digital media having a plurality of security tags co-located therewith;

FIG. 2 illustrates one embodiment of an article of merchandise comprising an article of digital media having a plurality of security tags co-located therewith;

FIG. 3 illustrates one embodiment of an article of merchandise comprising an article of digital media having a plurality of security tags co-located therewith, and authentication of the article of digital media;

FIG. 4 illustrates one embodiment of an article of merchandise comprising an article of digital media having a plurality of security tags co-located therewith, and authentication of the article of digital media;

FIG. 5 illustrates one embodiment of an article of merchandise comprising an article of digital media having a plurality of security tags co-located therewith, and authentication of the article of digital media;

FIG. 6 illustrates one embodiment of an article of merchandise comprising an article of digital media having a plurality of security tags co-located therewith, and authentication of the article of digital media; and

FIG. 7 is a flow diagram illustrating a process for validating an article of merchandise comprising an article of digital media according to one embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail so as not to obscure claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” and/or “an embodiment” in various places throughout this specification are not necessarily all referring to the same embodiment. Furthermore, the particular features, structures, and/or characteristics may be combined in one or more embodiments.

Unless specifically stated otherwise, as apparent from the following discussion, it is appreciated that throughout this specification discussions utilizing terms such as “providing”, “sending”, “receiving”, “determining”, “detecting”, “authenticating”, “scanning” and/or the like refer to the actions and/or processes that may be performed by a computing system, such as a computer or a similar electronic computing device, that manipulates and/or transforms data represented as physical, electronic and/or magnetic quantities and/or other physical quantities within the computing system's processors, memories, registers, and/or other information storage, transmission, reception and/or display devices. Accordingly, a computing system refers to a system or a device that includes the ability to process and/or store data in the form of signals. Thus, a computing system, in this context, may comprise hardware, software, firmware and/or any combination thereof. Further, unless specifically stated otherwise, a process as described herein, with reference to flow diagrams or otherwise, may also be executed and/or controlled, in whole or in part, by a computing system.

“Digital Media”, as referred to herein relates to articles of merchandise such as a storage medium adapted to store digital content. For example, an article of digital media may comprise a magnetic disk, magnetic tape, recordable media including DVD and CD, including HD-DVD, CD-R, CD-RW, DVD-R, memory devices such as flash memory and/or semiconductor devices that may have embodied thereon digital content in a format that is retrievable in response to requests and/or commands, and may, in some contexts, be referred to as digital media. “Digital Content” as referred to herein relates to digital information stored in a storage medium in some retrievable format. For example, digital content may comprise digital data embodied in a particular format, such as in one or more media formats such as MP3, MP4, WMA, WAV, EXE and MIDI formats. However, these are merely examples of media formats, and claimed subject matter is not limited in this respect, and may include any media format that may comprise digital media.

“Security Tags” as referred to herein relates to information that may be disposed on and/or co-located with articles of merchandise such as an article of digital media. Security tags may comprise, for example, information such as a manufacturers identification code, a content code, a digital watermark or an audio fingerprint, which may be co-located with an article of digital media by burning and/or pressing on a substrate, coupling Radio-Frequency Identification (RFID) circuitry to an article of digital media, or coupling a two or three-dimensional visual image, such as a hologram to an article of digital media, for example. However, additional types of tags now existing or later developed may be utilized in accordance with at least one embodiment, and claimed subject matter is not limited in scope to just these examples. Additionally, “authenticating” an article, as referred to herein relates to determining whether the article is what it is presented as being. In one embodiment, such an authentication of an article may comprise comparing information associated with a security tag co-located with the article with information obtained from a second source, such as an authentication database. However, the claimed subject matter is not so limited, and in alternative embodiments authentication may be performed by correlating information obtained from a security tag with a second source other than a database. The second source may comprise any data source that may provide information that may be correlated to perform authentication functions, for example.

The following discussion details several possible embodiments, although these are merely examples and are not intended to limit the scope of claimed subject matter. As another example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a recordable media that may have stored thereon instructions, that when executed by a system, such as a computer system, computing platform, or other system, for example, may result in an embodiment of one or more methods illustrated herein being executed.

As alluded to previously, it may be desirable, for a variety of reasons, to dispose security tags on articles of merchandise such as an article of digital media. Additionally, it may be desirable to provide a method of authenticating security tags disposed on an article of digital media. For example, it may be desirable to minimize the introduction of counterfeit CDs and DVDs into commerce. One potential way to minimize the introduction of counterfeit media may be to authenticate an article of digital media prior to a sale and/or when presented as a returned item. Additionally, it may be desirable to dispose security measures on an article of digital media when formed, whether formed in a manufacturing facility or formed “on demand” when an item is requested. In at least one embodiment, a method of authenticating an article of digital media by authenticating security tags may be employed in a retail environment. Additionally, in this context, security tags are described as being “disposed on” an article of digital media, but the claimed subject matter is not so limited. In one or more embodiments, security tags may be co-located with an article of digital media, meaning, for example, that the security tags may be proximate to the article of digital media. In one example, security tags may be co-located with an article of digital media by being disposed on retail packaging of the article of digital media. In this example embodiment, security tags may not be disposed on the article of digital media, but are co-located with the article of digital media. However, this is just one example, and other types of co-location between security tags and an article of digital media may be employed in other embodiments.

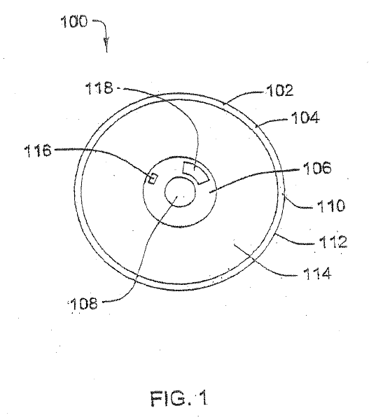

Referring now to FIG. 1, there is illustrated a one embodiment of an article of merchandise having a plurality of security tags co-located therewith. FIG. 1 comprises an article of digital media 100, which may comprise a CD or DVD, for example. Again, however, these are merely examples of digital media according to a particular embodiment and the claimed subject matter is not limited in this respect. Here, digital media 100 may comprise a CD or DVD, and may have digital content stored on track quadrants, for example. Additionally, digital media may have disposed thereon a plurality of security tags. For example, a media code 102, which may comprise an alphanumeric code in a particular embodiment, and may be pressed or burned on an index portion of the digital media 100 or within track quadrants designated for this purpose. A Manufacturers Identification (MID) code 104 may be pressed on the digital media 100, such as at the time of manufacture. Alternatively, digital media 100 may include an inner ring 106 and hole 108. RFID circuitry 116 may be disposed on inner ring 106 and, additionally, a visual image 118 such as a 2-dimensional or 3-dimensional holographic image may be formed on inner ring 106 or on another portion of the digital media. An audio tag 110 may be burned or pressed into the digital media 100 on one or more track quadrants, for example. However, these are merely examples of how a security tag may be associated with digital media according to a particular embodiment, and the claimed subject matter is not so limited.

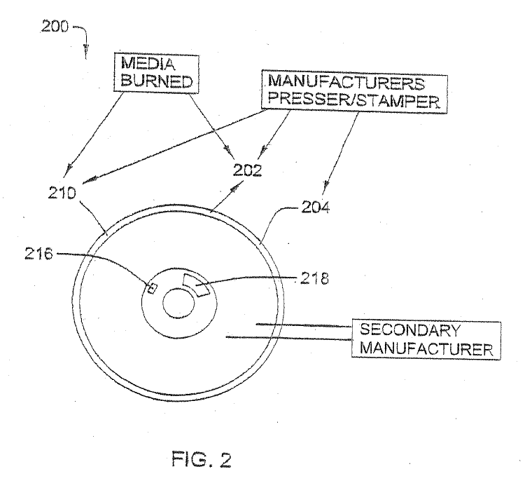

Referring now to FIG. 2, there is illustrated an article of merchandise comprising an article of digital media 200 having a plurality of security tags co-located therewith. Digital media 200 may comprise a CD or DVD, for example. Digital media 200 may have disposed thereon a plurality of security tags, such as a media code 202, a MID code 204, RFID circuitry 216, a visible graphic or mark 218, or an audio tag 210, for example. These security tags may be co-located with the digital media 200 by use of a variety of techniques. For example, a media burner may be employed to burn digital content on the digital media 200, and may additionally be employed to form the media code 202 and/or audio tag 210 thereon. Additionally, a manufacturer may employ a manufacturing process to form the media code 202, audio tag 210, MID code 204, RFID circuitry 216 or graphic or mark 218 on a burned digital media, for example. The manufacturing process may be employed after burning in the same fabrication process, or may be employed as a secondary manufacturing process, such as if the digital media is burned in a retail environment, for example. However, these are merely examples of how a security tag may be formed on digital media, and the claimed subject matter is not so limited.

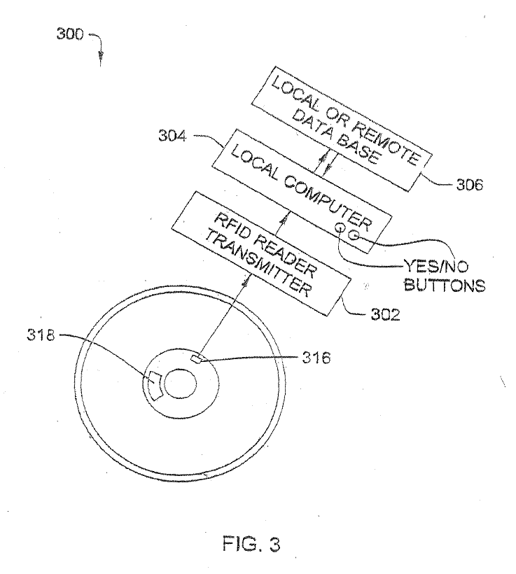

Referring now to FIG. 3, there is illustrated an article of merchandise comprising an article of digital media 300 having a plurality of security tags co-located therewith. Digital media 300 may comprise a CD or DVD, for example. Digital media 300 may have disposed thereon a plurality of security tags, such as RFID circuitry 316 and/or a visible image 318. As mentioned previously, it may be desirable to authenticate the digital media 300 from security tags disposed thereon. In one embodiment, authentication of digital media 300 may be performed by detecting information comprising a “signature” associated with digital media 300. Detecting a signature may comprise reading one or more security tags co-located with respect to digital media 300. For example, detecting a signature may comprise reading an RFID signal from RFID circuitry 316 to obtain RFID data. Reading an RFID signal may be performed by an RFID reader 302. The RFID data may be provided to a local computer 304, and may be employed to query database 306, which may be located on computer 304 and/or may be located on a computer remote from computer 304, such as a computer located at a physically different location that computer 304. The RFID data may be employed to query database 306, in order to authenticate digital media 300. For example, database 306 may be queried with the RFID data in order to determine whether the RFID data is associated with an authentic article of digital media. In this manner, digital media 300 may be authenticated by employing security tags. In one embodiment, authentication may include displaying data on a display device (not shown) of the computer 304. Additionally, authentication may include printing a receipt or executing an audible signal, for example.

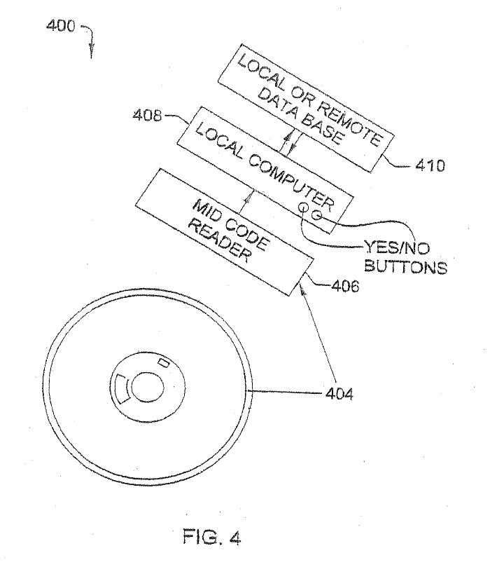

Referring now to FIG. 4, there is illustrated an article of merchandise comprising an article of digital media 400 having a security tag co-located therewith. In this embodiment, digital media 400 has a MID code 404 formed thereon. The MID code 404 may be authenticated, in one embodiment, by employing a MID code reader 406 to read the MID code. MID code reader 406 may comprise a DVD or CD reader, for example. Data read from the MID code 406 may be provided to a local computer 408, and may be provided to database 410. The MID code may be authenticated by querying database 410, for example. In this manner, digital media 400 may be authenticated by employing security tags. In one embodiment, authentication may include displaying data on a display device (not shown) of the computer 408. Additionally, authentication may include printing a receipt or executing an audible signal, for example.

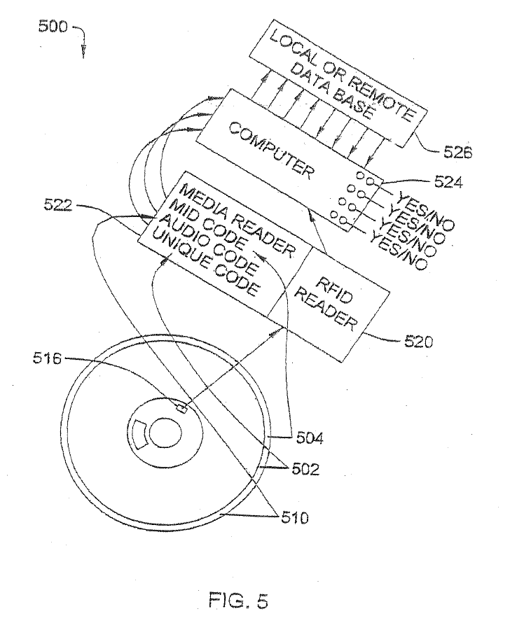

Referring now to FIG. 5, there is illustrated an article of merchandise comprising an article of digital media 500 having a plurality of security tags co-located therewith. In this embodiment, digital media 500 has RFID circuitry 516, a MID code 504, a media code 502 and an audio code 510 disposed thereon. In this embodiment, authentication may be performed by use of a plurality of the security tags. For example, an RFID signal from the RFID circuitry 516 may be read by an RFID reader 520. Additionally, the MID code 504, media code 502 and/or audio code 510 may be read by a media reader 520, such as a CD or DVD reader. Additionally, in at least one embodiment a reader may be adapted to read a plurality of security tags of differing types. For example, a reader may be adapted to read an RFID signal from RFID circuitry 516, read the audio code 510, read the media code 502 and read the MID code 504, for example. The reader may be adapted to read these security tags substantially automatically in response to providing the digital media to the reader, for example. Data read from the security tags may be provided to a local computer 524, and may be provided to database 526. The MID code may be used to authenticate an article by querying database 526, for example. In this manner, digital media 500 may be authenticated by employing security tags. In one embodiment, authentication may include displaying data on a display device (not shown) of the computer 524. Additionally, authentication may include printing a receipt or executing an audible signal, for example. In at least one embodiment, the security tags may be logged and tracked into database 526, to enable physical location, retail destination and/or current status of digital media 500, such as sold, returned or destroyed, for example. Tracking may be performed by use of a tracking database (not shown). In at least one embodiment, a retail outlet or manufacturer may utilize one or more unique security tags or a combination of security tags to identify and/or track digital media for one or more purposes.

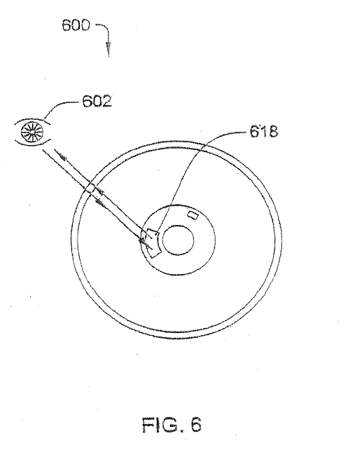

Referring now to FIG. 6, there is illustrated an article of merchandise comprising an article of digital media 600 having a security tag disposed thereon. In this embodiment, digital media 600 has a visible image 618 formed thereon. Here, digital media 600 may be authenticated upon authentication of visible image 618. Authentication of visible image 618 may be performed visually by a human eye 602. A verifier may be trained to recognize a valid visible image 618 or access a reference to authenticate visible image 618. The verifier may be capable of authenticating the digital media 600 by inspection of visible image 618.

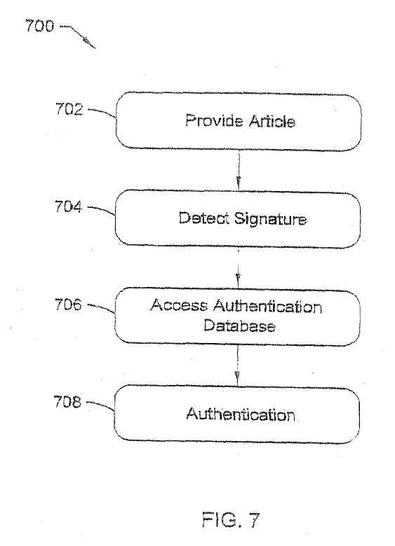

FIG. 7 is a flow diagram of a process 700 for authenticating security tags co-located on an article of merchandise according to an embodiment, to authenticate the article, for example. However, claimed subject matter is not limited in scope to this particular example. For example, for flow diagrams presented herein, the order in which blocks are presented does not necessarily limit claimed subject matter to any particular order. Additionally, intervening blocks not shown may be employed without departing from the scope of claimed subject matter. Likewise, flow diagrams depicted herein may, in alternative embodiments, may be implemented as a combination of hardware, software and/or firmware, such as part of a computer or computing system, for example.

Continuing with FIG. 7, at block 702, an article is provided. The digital media may have one or more security tags co-located therewith, and may comprise one or more of the security tags described with reference to FIGS. 1-6, for example. At block 704, a signature of the article may be detected. Detecting a signature may comprise obtaining information from the one or more security tags co-located with the digital media. In one embodiment, obtaining information from the one or more security tags comprises reading one or more security tags. Reading may be performed by physical inspection, by scanning by use of a scanning such as an RFID scanner or a reader which may be adapted to read a plurality of varying types of security tags, and/or other manners which may result in the detection and/or reading of security tags and/or information thereof. Detection and/or reading of security tags and/or information thereof may result in the obtaining of security tag information. At block 706 an authentication database is accessed. The authentication database may be utilized to authenticate an article based, at least in part, the security tag information. The security tag information may be employed to authenticate the article including the security tag. At block 708, an authentication of security tag information is performed, and, accordingly, authentication of the article is performed.

In the preceding description, various aspects of claimed subject matter have been described. For purposes of explanation, systems and configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method, comprising:
receiving a blank article of digital media comprising a machine readable memory region and a separate region having disposed thereon a first security tag;
recording digital content in the machine readable memory region using a digital media burner; and
recording a second security tag in the machine readable memory region using the digital media burner.

2. The method of claim 1, wherein the first security tag is disposed on the separate region at a first location for manufacturing the blank article of digital media and the second security tag is recorded in the machine readable memory region at a second different retail location.

3. The method of claim 1, wherein the machine readable memory region is configured to store the digital content and the separate region is an alignment ring structure.

4. The method of claim 1, wherein the second security tag is recorded onto the article of digital media after receiving a request for an on-demand purchase or rental of a memory storing the digital content.

5. The method of claim 4, wherein the first security tag is disposed on the article of digital media prior to receiving the request for the on-demand purchase or rental of the memory storing the digital content.

6. The method of claim 1, wherein the first security tag includes Radio Frequency IDentification (RFID) circuitry.

7. The method of claim 1, wherein the second security tag is a media code or audio tag.

8. The method of claim 1, further comprising:
detecting a signature associated with the article of digital media in response to reading the first security tag or the second security tag; and
authenticating the article of digital content according to the detected signature.

9. A method, comprising:
storing, using a computing device, digital content onto an article of digital media having a machine readable memory region and a separate region, wherein the digital content is encoded in the machine readable memory region;
storing, using the computing device, a first security tag in the article of digital media, wherein the first security tag is encoded in the machine readable memory region; and
disposing a second security tag on the separate region.

10. The method of claim 9, wherein the second security tag is disposed on the separate region at a first location for manufacturing the article of media and the first security tag is encoded in the machine readable memory region at a second different retail location.

11. The method of claim 9, wherein the first security tag is encoded in the machine readable memory region after receiving a request for an on-demand purchase or rental of a memory storing the digital content.

12. The method of claim 11, wherein the second security tag is disposed on the separate region prior to receiving the request for the on-demand purchase or rental of the memory storing the digital content.

13. The method of claim 9, wherein the second security tag includes Radio Frequency IDentification (RFID) circuitry.

14. The method of claim 9, wherein the first security tag is a media code or audio tag.

15. The method of claim 9, further comprising:
detecting a signature associated with the article of digital media in response to reading the first security tag or the second security tag; and
authenticating the article of digital content according to the detected signature.

16. An apparatus, comprising:
a first region configured to store digital content; and
a second region configured to position the apparatus in a machine and enable the machine to access the first region;
wherein a first security tag is encoded in the first region and a second security tag is disposed on the second region.

17. The apparatus of claim 16, wherein the first region comprises an inner ring of the apparatus and the second region comprises an outer ring of the apparatus.

18. The apparatus of claim 16, wherein the first security tag comprises Radio Frequency IDentification (RFID) circuitry and the second security tag comprises a media code or audio tag.

19. An apparatus, comprising:
means for positioning the apparatus in a machine to enable the machine to accessing digital content stored thereon;
means for storing the digital content; and
a first security tag disposed on the positioning means; and
a second security tag encoded in the storing means.

20. The apparatus of claim 19, wherein the first security tag comprises Radio Frequency IDentification (RFID) circuitry and the second security tag comprises a media code or audio tag encoded in the storing means.

21. The apparatus of claim 19, wherein the first security tag is a visible graphic marked on the positioning means:
